(19) United States
(12) Patent Application Publication
(10) Pub. No.: US 2017/0367365 A1
(43) Pub. Date: Dec. 28, 2017

(54) METHODS FOR PROCESSING VEGETABLE OILS AND VEGETABLE OIL COMPOSITIONS

(71) Applicant: Imerys Talc Europe, Toulouse (FR)

(72) Inventor: Michael GREENHILL-HOOPER, Miradoux (FR)

(21) Appl. No.: 15/540,449

(22) PCT Filed: Dec. 22, 2015
(86) PCT No.: PCT/EP2015/080919

§ 371 Date: Jun. 28, 2017

(30) Foreign Application Priority Data
Dec. 29, 2014 (EP) 14290402.8

(51) Int. Cl. A23D 9/007; A23D 9/04; C11B 7/00

(52) U.S. Cl. CPC A23D 9/007; C11B 7/0083; A23D 9/04; C11B 7/0075

(57) ABSTRACT

A method for processing natural oil is provided. The method includes providing a natural oil to be processed, adding an inorganic particulate material to said natural oil, and processing the resulting mixture to obtain oil products with an improved yield and/or quality.

### TECHNICAL FIELD

The present invention is directed to methods for processing vegetable oils, to vegetable oil compositions, and to use of inorganic particulate material as an adjuvant for vegetable oil processing.

### BACKGROUND OF THE INVENTION

Vegetable oils are typically extracted from a plant host by a variety of techniques such as milling, distillation, expression, solvent extraction, or maceration. After optional refining, the recovered oil is generally subsequently processed to be separated into sub-products of differing properties. This processing is for example conducted by fractionation, which can be either dry fractionation or wet fractionation, the latter implying that solvents or detergents are being used.

In the dry fractionation process, a preferred process since it does not involve the addition of solvents or detergents, the vegetable oil is submitted to controlled cooling with agitation, in order to separate the oil into liquid and solid fractions obtained by crystallisation.

The liquid fraction—in some cases termed “olein”—is considered the higher value fraction and contains higher levels of unsaturated fats represented by a relatively high iodine value, for example equal to or greater than about 56.

The solid fraction—in some cases termed “stearin”—has a lower iodine value, generally of less than about 36.

At the end of the crystallisation process, the two fractions can be separated by filtration, e.g. by using a membrane filter press, or in a decanter or super decanter.

The process may thereafter be repeated, starting with the liquid fraction of the first processing step, in order to further refine it. This may for example yield the further refined products known as “super olein” and “palm soft mid-fraction”.

The industrial processing of vegetable oils is governed by parameters such as the yield of the recovered fractions as well as their qualities measured for example by their individual iodine value, used as an indicator of their levels of saturation.

Increasing the yields of the oils fractions, the iodine value of the olein fraction, the drop point of the low iodine value fraction, as well as the difference in iodine value between the fractions, are goals with significant commercial importance, and new processes achieving these goals are highly desirable.

The total processing time of vegetable oils is also a commercially important parameter in an industrial setting, and reduction in this processing time is a sought after improvement.

### SUMMARY OF THE INVENTION

According to a first aspect of the present invention, there is provided a method for processing vegetable oils comprising providing a vegetable oil to be processed, adding an inorganic particulate material to said vegetable oil, and processing the resulting mixture to obtain oil products. In certain embodiments, the addition of the inorganic particulate material may occur before, during, or at the end of the processing. In particular embodiments, the processing comprises fractionation by controlled cooling.

In accordance with a second aspect of the present invention, there is provided a method for further processing oil products comprising providing an oil product to be further processed, adding an inorganic particulate material to said product, and further processing the resulting mixture to obtain further refined oil products.

In accordance with a third aspect of the present invention, there is provided a vegetable oil composition, or an oil product composition, comprising a solid fraction which contains an inorganic particulate material. In particular embodiments, the solid fraction is crystallised in the β prime polymorph.

In accordance with a fourth aspect of the present invention, use of inorganic particulate material as an adjuvant in the processing of vegetable oil is provided.

### DETAILED DESCRIPTION OF THE INVENTION

### Definitions

As used herein, the terms “crystallised in the beta prime conformation”, designates fat and triglycerides crystals which are primarily made of the beta prime polymorph, with the alpha and beta polymorphs representing minority species. In specific embodiments, “crystallised in the beta prime conformation” covers crystals where 30% or more, 40% or more, 50% or more, 60% or more, 70% or more, 75% or more, 80% or more, 85% or more, 90% or more, 95% or more of the crystals re in the beta prime conformation.

The 3 major polymorphic forms of fat crystals are alpha, beta prime and beta, in order of increasing stability, melting point and density. As is known in the art, crystal polymorphism may be assessed by powder x-ray diffraction, each of the 3 polymorphs giving characteristic spectra in the small angle (long spacings) and wide angle (short spacings) x-ray scattering regions. See for example the book “Structure and Properties of Fat Crystal Networks”, by Alejandro G. Marangoni and Leendert H. Wesdorp published in its second edition by CRC Press on Sep. 25, 2012.

In the processing of vegetable oils, crystal in the beta prime conformation are highly desirable since they trap the minimum amount of liquid during filtration.

As used herein, “vegetable oil” covers any oil of plant origin, such as palm, palm kernel, soybean, rapeseed, sunflower, peanut, cottonseed, coconut oils. In certain embodiments, the vegetable oil is Refined, Bleached and Deodorized oil.

As used herein, the terms “oil products” cover oil components which have already been submitted to a first processing step after the extraction of the oil from the plant.

As used herein, the term “talc” means either the magnesium silicate mineral, or the mineral chlorite (magnesium aluminium silicate), or a mixture of the two, optionally associated with other minerals, for example, dolomite and/or magnesite, or furthermore, synthetic talc.

As used herein, “specific surface area (BET)” means the area of the surface of the particles of the talc particulate with respect to unit mass, determined according to the BET method by the quantity of nitrogen adsorbed on the surface of said particles so to as to form a monomolecular layer completely covering said surface (measurement according to the BET method, AFNOR standard X11-621 and 622 or ISO 9277). In certain embodiments, specific surface is determined in accordance with ISO 9277, or any method equivalent thereto.

As used herein, “cycle time of the processing method” means the total time elapsed from the initiation of the heating to melt all crystals and seeds present in the starting material to the end of the cooling, before filtration of the output products is initiated.

As used herein, “drop point” means the temperature at which the first drop of melting fat will drip from a grease cup.

### Oil Processing Method

In certain embodiments, the method of processing vegetable oil according to the invention may comprise the following steps of:
1. heating the oil to such a temperature and for such a time that all crystals and seeds are melted;
2. adding an inorganic particulate material to the heated oil;
3. rapidly cooling the mixture to a temperature close to the crystallisation temperature of the oil;
4. maintaining the temperature constant to allow crystallisation to happen;
5. once the crystallisation is complete, filtering the resulting oil products.

In other embodiments, the addition of the inorganic particulate material of step 2 is performed before step 1, during step 1, after step 3 or during step 3. In particular embodiments, the addition occurs when the oil temperature is above its metastable range.

In certain embodiments, the inorganic particulate material is added directly in a powder form to the oil. In other embodiments, the inorganic particulate material is firstly mixed and dispersed in a small volume of oil heated at the same temperature as the bulk of the oil, prior to the resulting particulate dispersion in oil being mixed with the bulk of the oil. In other embodiments, the method of processing vegetable oil according to the invention uses an additional step after step 4, once the crystallisation is complete, and before step 5, which additional step permits further cooling of the oil products.

In certain embodiments, the method of further processing oil products according to the invention may comprise the following steps:
1. heating the oil product to such a temperature and for such a time that all crystals and seeds are melted;
2. adding an inorganic particulate material to the heated oil product;
3. rapidly cooling the mixture to a temperature close to the crystallisation temperature of the oil product;
4. maintaining the temperature constant to allow crystallisation to happen;
5. once the crystallisation is complete, filtering the resulting further refined oil products.

In other embodiments, the addition of the inorganic particulate material of step 2 is performed before step 1, during step 1, after step 3 or during step 3. In particular embodiments, the addition occurs when the oil product temperature is above its metastable range.

In certain embodiments, the inorganic particulate material is added directly in a powder form to the oil product. In other embodiments, the inorganic particulate material is firstly mixed and dispersed in a small volume of oil product heated at the same temperature as the bulk of the oil product, prior to the resulting particulate dispersion in oil product being mixed with the bulk of the oil product.

In other embodiments, the method of further processing oil products according to the invention uses an additional step after step 4, once the crystallisation is complete, and before step 5, which additional step permits further cooling of the further refined oil products.

In certain embodiments, the inorganic particulate material is added to the vegetable oil, or to the oil product, in an amount ranging from about 0.001% to less than 1% based on the weight of the starting oil or of the starting oil product, respectively. In other embodiments, the inorganic particulate material is added to the vegetable oil, or to the oil product, in an amount ranging from about 0.003% to about 0.5% based on the weight of the starting oil or of the starting oil product, respectively. In yet other embodiments, the inorganic particulate material is added to the vegetable oil, or to the oil product, in an amount ranging from about 0.01% to about 0.1% based on the weight of the starting oil or of the starting oil product, respectively. In particular embodiments, the inorganic particulate material is added to the vegetable oil, or to the oil product, in an amount of about 0.02%, about 0.03%, about 0.05%, or about 0.075%, based on the weight of the starting oil or of the starting oil product, respectively.

The resulting oil products may be recovered by filtration. For instance, membrane pressure filtration is used. In certain embodiments, a pressure of about 6 Bars is applied to the membrane filtration system to recover the solid and the liquid oil products resulting from the processes according to the invention. In other embodiments, the resulting oil products may be recovered in a decanter or in a super decanter.

Without being bound by a particular theory, it is believed that the inorganic particulate material added during the processing of vegetable oils and oil products acts as an adjuvant which enhances, aids, or increases the separation of the oil fractions with high iodine values from the oil fractions with lower iodine values. In the case of processing methods involving differential crystallisation of part of the vegetable oil or oil product to be processed, it is believed that the inorganic particulate material acts as a seed for crystal growth. This results in a number of advantages, such as an accelerated crystal growth allowing to reduce the cycle time of the processing, crystal formation in a more controlled number and rate, higher extent of crystallization allowing higher yields and quality, and the formation of crystal in a size and polymorph conformation which are easier to filtrate in the subsequent step of the process, thus allowing more efficient separation of the liquid and the solid phases.

It is also believed that the use of inorganic particulate material permits more reproducible results to be obtained, thus allowing fixed processing parameters to be used which in turns lead to the delivery of oil products with a consistent quality.

In certain embodiments, use of an inorganic particulate material as an adjuvant in the processing of vegetable oil, or in the further processing of oil products, results in the reduction of the cycle time of the processing method by at least 2%. In other embodiments, use of an inorganic particulate material as an adjuvant in the processing of vegetable oil, or in the further processing of oil products, results in the reduction of the cycle time of the processing method by at least 5%, by at least 6%, by at least 7%, by at least 10%, or by at least 15%.

In certain embodiments, use of an inorganic particulate material as an adjuvant in the processing of vegetable oil, or in the further processing of oil products, results in the yield of the high iodine value fraction increasing by at least 1%. In other embodiments, use of an inorganic particulate material as an adjuvant in the processing of vegetable oil, or in the further processing of oil products, results in the yield of the high iodine value fraction increasing by at least 2%, by at least 5%, or by at least 10%. In yet other embodiments, use of an inorganic particulate material as an adjuvant in the processing of vegetable oil, or in the further processing of oil products, does not decrease the yield of the high iodine value fraction.

In certain embodiments, use of an inorganic particulate material as an adjuvant in the processing of vegetable oil results in the olein yield being greater than 65%, greater than 68%, greater than 70%, greater than 72%, greater than 74%, greater than 75% greater than 76%, greater than 77%, greater than 78%, greater than 79%, greater than 80%, or greater than 81%.

In certain embodiments, use of an inorganic particulate material as an adjuvant in the processing of vegetable oil, or in the further processing of oil products, results in the iodine value of the high iodine value fraction increasing by at least 0.1 unit. In other embodiments, use of an inorganic particulate material as an adjuvant in the processing of vegetable oil, or in the further processing of oil products, results in the iodine value of the high iodine value fraction increasing by at least 0.2, by at least 0.5, or by at least 1 unit. In yet other embodiments, use of an inorganic particulate material as an adjuvant in the processing of vegetable oil, or in the further processing of oil products, does not decrease the iodine value of the high iodine value fraction.

In certain embodiments, use of an inorganic particulate material as an adjuvant in the processing of vegetable oil results in the olein iodine value being greater than 55, greater than 56, greater than 57, greater than 58, greater than 59, greater than 60, greater than 61, greater than 62, greater than 63, greater than 64, greater than 65, or greater than 66.

In certain embodiments, use of an inorganic particulate material as an adjuvant in the processing of vegetable oil, or in the further processing of oil products, results in the iodine value of the low iodine value fraction decreasing by at least 0.1 unit. In other embodiments, use of an inorganic particulate material as an adjuvant in the processing of vegetable oil, or in the further processing of oil products, results in the iodine value of the low iodine value fraction decreasing by at least 0.2, by at least 0.5, or by at least 1 unit.

In certain embodiments, use of an inorganic particulate material as an adjuvant in the processing of vegetable oil results in the stearin iodine value being lower than 33, lower than 32, lower than 31, lower than 30, or lower than 29.

In certain embodiments, use of an inorganic particulate material as an adjuvant in the processing of vegetable oil, or in the further processing of oil products, results in the difference in iodine value between the high iodine value fraction and the low iodine value fraction increasing by at least 0.1 unit. In other embodiments, use of an inorganic particulate material as an adjuvant in the processing of vegetable oil, or in the further processing of oil products, results in the difference in iodine value between the high iodine value fraction and the low iodine value fraction increasing by at least 0.2, by at least 0.5, or by at least 1 unit.

Unless otherwise stated, iodine values referred to herein for the oil components are as measured in a well known manner by the Wijs method. In a typical procedure, the oil component to be analyzed is treated with an excess of iodine monochloride solution in glacial acetic acid. Unreacted iodine monochloride is then allowed to react with potassium iodide, converting it to iodine, whose concentration is determined by titration with sodium thiosulfate. In certain embodiments, the iodine value is measured as described in the AOCS official method referenced “Ja 14-91”, available from the American Oil Chemists' Society (2710 S. Boulder, Urbana, Ill. 61802-6996 USA and http://www.aocs.org). In this method, the iodine value indicates the grams of iodine which reacts with 100 grams of lecithin.

In certain embodiments, use of an inorganic particulate material as an adjuvant in the processing of vegetable oil, or in the further processing of oil products, results in the drop point of the low iodine value fraction increasing by at least 0.1° C. In other embodiments, use of an inorganic particulate material as an adjuvant in the processing of vegetable oil, or in the further processing of oil products, results in the drop point of the low iodine value fraction increasing by at least 0.2° C., by at least 0.5° C., by at least 1.0° C., by at least 1,5° C. or by at least 2.0° C.

In certain embodiments, use of an inorganic particulate material as an adjuvant in the processing of vegetable oil, or in the further processing of oil products, results in a well-controlled crystallisation, as indicated by the absence of any observable increase in oil temperature upon crystallisation.

In certain embodiments, the processing methods of the invention are performed in a crystallization tank equipped with a stirring device and a cooling device.

### Inorganic Particulate Material Adjuvant

In certain embodiments, the inorganic particulate material may be a silicate mineral. In further embodiments, the inorganic particulate material may be a phyllosilicate, for example a clay mineral such as bleaching clays including calcium montmorillonite (bentonite), attapulgite, sepiolite, and mixtures thereof. In yet further embodiments, the inorganic particulate material may be selected from the group consisting of talc, an alkaline earth metal carbonate or sulphate, such as calcium carbonate (natural ground or precipitated), magnesium carbonate, dolomite, gypsum, a hydrous kandite clay such as kaolin, halloysite or ball clay, an anhydrous (calcined) kandite clay such as metakaolin or fully calcined kaolin, mica, perlite, feldspars, nepheline syenite, wollastonite, diatomaceous earth, barite, glass, and natural or synthetic silica or silicates. The inorganic particulate material may be a natural or synthetic inorganic particulate material.

In particular embodiments, the inorganic particulate material may be a macro or microcrystalline talc. The individual platelet size, i.e. the median diameter as measured by the Sedigraph method, of an individual talc platelet (a few thousand elementary sheets) can vary from approximately 1 μm to over 100 μm, depending on the conditions of formation of the deposit. The individual platelet size determines the lamellarity of the talc. A highly lamellar talc will have large individual platelets, whereas a microcrystalline talc will have small platelets. Although all talcs may be termed lamellar, their platelet size differs from one deposit to another. Small crystals provide a compact, dense ore, known as microcrystalline talc. Large crystals come in papery layers, known as macrocrystalline talc. Known microcrystalline talc deposits are located in Montana (Yellowstone) and in Australia (Three Springs). In a microcrystalline structure, talc elementary particles are composed of small plates compared to macrocrystalline structures, which are composed of larger plates.

In other embodiments, the inorganic particulate material may be a chloritic talc.

In certain embodiments, the inorganic particulate material is a food additive grade inorganic particulate material. Such grades are defined for example by the Food Chemical Codex published by the US Pharmacopeial Convention or by the European Commission Regulation N °231/2012.

In particular embodiments, the inorganic particulate material may be provided in the form of an agglomerate, pellet, or compacted composition.

The inorganic particulate material has d₅₀ of from about 0.5 to about 30 pm and/or a d₉₀ of from about 15 to about 50 μm and/or a d₉₅ of from about 15 to about 70 μm. In certain embodiments, the inorganic particulate material composition has a d₅₀ of from about 0.5 to about 30 μm, a d₉₀ of from about 15 to about 50 μm, and a d₉₅ of from about 15 to 70 μm.

The microcrystalline talc according to certain embodiments of the present invention may have a d₅₀ ranging from 0.5 to 10 μm. For example, the d₅₀ of the microcrystalline talc may be ranging from 1.0 to 7.5 μm, such as 1.0 to 5 μm, or 3.0 to 4.5 μm.

Unless otherwise stated, particle size properties referred to herein for the inorganic particulate materials are as measured in a well known manner by sedimentation of the particulate material in a fully dispersed condition in an aqueous medium using a Sedigraph 5100 machine as supplied by Micromeritics Instruments Corporation, Norcross, Ga., USA (web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₅ is the value determined in this way of the particle e.s.d at which there are 50% by weight of the particles which have an equivalent spherical diameter less than that d₅₀ value.

In certain embodiments, the inorganic particulate material has a d₁₀ of from about 0.5 to about 15 μm, for example, from about 0.5 to about 12 μm, or from about 0.5 to about 10 μm, or from about 1 to about 15 μm, or from about 1 to about 12 μm, or from about 1 to about 10 μm, or from about 3 to about 15 μm, or from about 3 to about 12 μm, or from about 3 to about 10 μm, or from about 5 to about 15 μm, or from about 5 to about 12 μm, or from about 5 to about 10 μm, or from about 7 to about 15 μm, or from about 7 to about 12 μm, or from about 7 to about 10 μm.

In certain embodiments, the inorganic particulate material has a d₉₀ of from about 15 to about 50 μm, for example, from about 15 to about 45 μm, or from about 15 to about 40 μm.

In certain embodiments, the inorganic particulate material has a d₉₅ of from about 15 to about 70 μm, for example, from about 15 to about 60 μm, or from about 15 to about 55 μm, or from about 15 to about 50 μm, or from about 15 to about 20 μm, or from about 15 to about 18 μm.

In certain embodiments, the inorganic particulate material has a do of less than about 1 μm, and/or a d₁₀ of less than about 4 μm, and/or a d₅₀ of less than about 10 μm, and/or a d₉₀ of less than about 20 μm, and/or a d₉₅ of less than about 20 μm. In certain embodiments, the inorganic particulate material has a d₀ of from about 0.4 to about 0.75 μm, and/or a d₁₀ of from about 0.5 to about 2.75 μm, and/or a d₅₀ of from about 1 to about 12 μm, and/or a d₉₅ of from about 15 to about 18 μm.

Furthermore, the inorganic particulate materials according to certain embodiments of the present invention may have a surface BET area in the range of 3 to 25 m²·g⁻¹, such as for example from 3 to 20 m²·g⁻¹, or from 3 to 15 m²·g⁻¹, or from 3 to 10 m²·g⁻¹. In the cases where the inorganic particulate materials comprise synthetic talc, the materials may have a surface BET area in excess of 100 m²·g⁻¹. As used herein, the surface BET area is the specific surface area measured according to DIN ISO 9277.

In certain embodiments, the inorganic particulate material has a Hegman fineness of 3.0 or more, for example, from about 3.0 to about 4.5, or from about 3.0 to about 4.25, or from about 3.0 to about 4.0. In certain embodiments, the inorganic particulate material agglomerate composition has a Hegman fines of about 3.0, or about 3.25, or about 3.5, or about 3.75, or about 4.0, or about 4.25, or about 4.5. In certain embodiments, the inorganic particulate material has a Hegman fineness which is within the range of ±1 of the Hegman fineness of the inorganic particulate material feed material from which the inorganic particulate material is prepared, for example, within the range of ±0.5 or, for example, within the range of ±0.25 of the Hegman fineness of the inorganic particulate material feed material. The test for measuring Hegman fineness is based on a ASTM D-1210-05 (2010). In a preferred method, 25 g of vegetable oil are provided. After adding 5 g sample, the mixture is kept stirring for 15 to 30 seconds. When no dry powder is visually present, mixing speed is increase to the highest reasonable speed without splashing the sample and mixing is continued for at least 2 minutes. Using a spatula or glass rod, the dispersion is stirred manually. A small amount of dispersed sample is placed in the deep end of the path of the Hegman fineness gage (Precision Gage & Tool Co., Dayton, Ohio). By using a steel draw-down blade/scraper, the material is then drawn down the length of the path toward the shallow end of the gage with a uniform, brisk motion. The fineness reading, in Hegman units (0-8) is obtained by observing the point where the material first shows a definite speckled pattern. Typical fineness patterns described in the ASTM D 1210-05 (2010) procedure can be used for comparison.

In specific embodiments, the inorganic particulate material is Luzenac talc. In further embodiments, the Luzenac talc is Luzenac Pharma, Luzenac OO, Extra A or Luzenac G20F talc. In further embodiments, the inorganic particulate material has a CAS n °14807-96-6.

In yet further embodiments, the inorganic particulate material has a BET (ISO 9277) of from about 3 m²/g to about 6 m²/g, a density (ISO 787/10) of about 3 g/cm³, a tapped density (ISO 787/11) of from about 0.4 g/cm³ to about 0.9 g/cm³, a loose density (EN 1097/3) of from about 0.2 g/cm³ to about 0.5 g/cm³, a hardness (Mohs scale) of about 1, a moisture (105° C.) (ISO 787/2) of less than about 0.5%, and a particle size distribution with a median diameter from about 3 microm to about 11 microm (Sedigraph 5100—sedimentation analysis, Stokes' Law—ISO 13317-3) and from about 8 microm to about 17 microm (Laser Mastersizer 2000—laser diffraction, Mie Theory—ISO 13320-1).

In still further embodiment, Luzenac OO is used as the inorganic particulate material. In yet further embodiments, the inorganic particulate material has a BET (ISO 9277) of about 3 m²/g, a density (ISO 787/10) of about 2.8 g/cm³, a tapped density (ISO 787/11) of about 0.9 g/cm³, a loose density (EN 1097/3) of about 0.45 g/cm³, a hardness (Mohs scale) of about 1, a moisture (105° C.) (ISO 787/2) of less than about 0.5 %, an oil absorption (ISO 787/5) of about 36 ml/100 g and a particle size distribution with a median diameter of about 11 microm (Sedigraph 5100—sedimentation analysis, Stokes' Law—ISO 13317-3) and of about 17 microm (Laser Mastersizer 2000—laser diffraction, Mie Theory—ISO 13320-1).

In certain embodiments, the inorganic particulate material has a particle size and particle size distribution allowing it to be removed from the solid fraction when it is re-melted.

### Compositions and Uses

As described above, certain embodiments of the method of the present invention produce a vegetable oil composition, or an oil product composition, comprising a solid fraction which contains an inorganic particulate material. In certain embodiments, the solid fraction of the vegetable oil composition, or of the oil product composition, constitutes by weight at least 5% of the total weight of the composition. In other embodiments, the solid fraction of the vegetable oil composition, or of the oil product composition, constitutes by weight at least 10%, at least 20%, at least 30%, at least 40%, at least 50%, at least 60%, at least 70%, at least 80%, at least 90%, at least 95%, or at least 99% of the total weight of the composition.

In certain embodiments, the inorganic particulate material constitutes by weight from about 0.001% to less than 1% of the total weight of the composition. In other embodiments, the inorganic particulate material constitutes by weight from about 0.003% to about 0.5%, from about 0.01% to about 0.1%, from about 0.02% to about 0.05% of the total weight of the composition, or constitutes by weight about 0.02%, about 0.03%, about 0.04%, about 0.05% of the total weight of the composition.

In certain embodiments, the inorganic particulate material constitutes by weight from about 0.005% to less than 5% of the weight of the solid fraction in the composition. In other embodiments, the inorganic particulate material constitutes by weight from about 0.015% to about 2.5%, from about 0.05% to about 0.5%, from about 0.1 % to about 0.25% of the weight of the solid fraction in the composition, or constitutes by weight about 0.1%, about 0.15%, about 0.2% of the weight of the solid fraction in the composition.

In certain embodiments, the solid fraction of the vegetable oil composition, or of the oil product composition, according to the invention is crystallised in the β prime polymorph. In certain embodiments, the solid fraction of the vegetable oil composition, or of the oil product composition, according to the invention is constituted of crystals where 50% or more, 60% or more, 70% or more, 75% or more, 80% or more, 85% or more, 90% or more, 95% or more of the crystals are in the beta prime conformation.

A characteristic parameter of the compositions of the invention is the drop point, defined as the temperature at which the first drop of melting fat will drip from a grease cup. In particular, the drop point is used to characterize the low iodine value fraction. For this fraction, a high drop point is desirable. In certain embodiments, the drop point of the low iodine value fraction is increased by at least 0.1° C. by the addition of the inorganic particulate material of the invention. In other embodiments, the drop point of the low iodine value fraction is increased by at least 0.2° C., by at least 0.5° C., by at least 1.0° C., by at least 15° C. or by at least 2.0° C. by the addition of the inorganic particulate material of the invention.

As described above, in certain embodiments, use of inorganic particulate material as an adjuvant in the processing of vegetable oil, or of oil products, is provided.

For the avoidance of doubt the present invention also embraces the following subject-matter as defined in the following numbered paragraphs.
1. A method for processing a vegetable oil comprising a step of adding an inorganic particulate material to the oil.
2. The method according to paragraph 1 wherein the processing is performed by controlled cooling.
3. The method according to paragraph 1 or 2 wherein the inorganic particulate material is added as a particulate dispersion in oil.
4. The method according to paragraph 1, 2 or 3 wherein the inorganic particulate material is added at a temperature higher than the crystallisation temperature.
5. The method according to paragraph 1, 2 or 3 wherein the inorganic particulate material is added at a temperature above the metastable region.
6. The method according to any one of paragraphs 1 to 5, wherein the iodine value of the high iodine value fraction obtained by said method is not lower than the iodine value of the high iodine value fraction obtained in the same processing method but in the absence of any inorganic particulate material.
7. The method according to any one of paragraphs 1 to 6, wherein the yield of the high iodine value fraction obtained by said method is not lower than the yield of the high iodine value fraction obtained in the same processing method but in the absence of any inorganic particulate material.
8. The method according to any one of paragraphs 1 to 7, wherein the iodine value of the low iodine value fraction obtained by said method is below 32.
9. The method according to any one of paragraphs 1 to 8, wherein 50% or more of the crystals in the solid fraction are in the beta prime conformation.
10. A vegetable oil composition comprising a solid fraction which contains an inorganic particulate material.
11. The vegetable oil composition of paragraph 10 wherein the inorganic particulate material constitutes from about 0.005% to about 5% w/w of the weight of the solid fraction in the composition.

### EXAMPLES

In all the examples, the following experimental parameters were used:
the starting material is an RDB palm oil with an iodine value of 52.1 and a drop point of 36.5° C.;
3.3 kg of oil are used for each example;
the oil is brought to 80° C. and maintained at this temperature for two hours;
the oil is subsequently rapidly cooled to 35° C. under constant agitation in a stainless steel crystallisation tank.

### Comparative Example 1

In this comparative example, a standard crystallisation test is performed.

After the rapid cooling to 35° C. described above, the oil is slowly cooled to 30° C. to allow crystallisation to begin.

When crystallisation is complete, the temperature is brought to 20° C. and the crystal suspension is filtered using a membrane filter with a compacting pressure of 6 Bars.

The results of the test are the following:

| | | | |
|---|---|---|---|
| Liquid fraction | Iodine Value | Yield (%) | Cloud Point (° C.) |
| (Olein) | 57.3 | 80.4 | 8.5 |
| Solid Fraction | Iodine Value | | Drop Point (° C.) |
| (Stearin) | 32.6 | | 52.3 |
| Cycle length | 6 h | | |

These values are in good agreement with the expected values for the starting material.

### Comparative Example 2

In this comparative example, an accelerated crystallisation test is performed.

After the initial rapid cooling to 35° C. described above, the rapid cooling is continued down to 30° C.

The temperature is maintained at 30° C. until crystallisation is complete, which takes 2 h 30. As in the previous example, the temperature is then brought to 20° C. and the crystal suspension is filtered using a membrane filter with a compacting pressure of 6 Bars.

The results of the test are the following:

| | | | |
|---|---|---|---|
| Liquid fraction | Iodine Value | Yield (%) | Cloud Point (° C.) |
| (Olein) | 57.3 | 79.4 | 8 |
| Solid Fraction | Iodine Value | | Drop Point (° C.) |
| (Stearin) | 32.8 | | 52.1 |
| Cycle length | 5 h 20 | | |

Because of the continuous rapid cooling down to 30° C., no nuclei are being formed, and the olein yield therefore decreases by 1% by comparison with comparative example 1. Furthermore, the crystals produced in comparative example 2 were fewer and larger than those produced in comparative example 1.

Finally, the rise in temperature associated with the release of the latent enthalpy of crystallisation was observed to be 0.3° C., a further indication that all the crystals appeared rapidly and in an uncontrolled manner. When crystallisation is well controlled, no increase in oil temperature is observed upon crystallisation.

### Example 3

In this example, an accelerated crystallisation test is performed wherein Luzenac talc is used to seed the crystallisation.

The operating conditions are those of the comparative example 2 above, except that when the oil reaches 70° C. in the rapid cooling phase, 100 ml of oil are taken out of the crystallisation tank and used to mix and disperse 1 gr of Luzenac OO talc, thus representing 0.03% of the total mass. When the crystallisation tank reaches 65° C., the oil and talc mixture is slowly added to the oil in the crystallisation tank using high level mixing.

The results of the test are the following:

| | | | |
|---|---|---|---|
| Liquid fraction | Iodine Value | Yield (%) | |
| (Olein) | 57.3 | 79.0 | |
| Solid Fraction | Iodine Value | | Drop Point (° C.) |
| (Stearin) | 30.2 | | 52.5 |
| Cycle length | 5 h | | |

By comparison to comparative example 2, the Stearine iodine value is significantly lower and the cycle length has been reduced by 6%. The crystals produced in this example 3 were smaller, and of a more reproducible size than the crystals produced in comparative example 2.

By comparison to comparative example 1, the Stearine iodine value is significantly lower and the cycle length has been reduced by almost 17%.

### Example 4

This example is a replication of Example 3.

The results of the test are the following:

| | | | |
|---|---|---|---|
| Liquid fraction | Iodine Value | Yield (%) | |
| (Olein) | 57.3 | 78.9 | |
| Solid Fraction | Iodine Value | | Drop Point (° C.) |
| (Stearin) | 30.5 | | 52.4 |
| Cycle length | 5 h | | |

It can be seen that the process according to the invention delivers reproducible results.

### Example 5

This example is a replication of Example 3 except that 100 mg of Luzenac OO talc is added (instead of 1 g), thus representing 0.003% of the total mass.

The results of the test are the following:

| | | | |
|---|---|---|---|
| Liquid fraction | Iodine Value | Yield (%) | |
| (Olein) | 57.3 | 79.0 | |
| Solid Fraction | Iodine Value | | Drop Point (° C.) |
| (Stearin) | 32.2 | | 52.1 |
| Cycle length | 4 h 45 | | |

Under these conditions, the cycle length was further reduced to 4 h 45 while maintaining the liquid fraction parameters constant.

### Example 6

This example is a replication of Example 3 except that 3.35 g of Luzenac OO talc is added (instead of 1 g), thus representing 0.1% of the total mass.

The results of the test are the following:

| | | | |
|---|---|---|---|
| Liquid fraction | Iodine Value | Yield (%) | |
| (Olein) | 57.1 | 78.8 | |
| Solid Fraction | Iodine Value | | Drop Point (° C.) |
| (Stearin) | 32.9 | | 52.0 |
| Cycle length | 4 h 50 | | |

Under these conditions, the cycle length was reduced to 4 h 50 while maintaining the liquid fraction parameters relatively similar.

1. A vegetable oil composition comprising a solid fraction, said solid fraction comprising from about 0.001 % to less than 1 % w/w of the total weight of the composition of an inorganic particulate material, wherein the inorganic particulate material is selected from the group consisting of talc, calcium carbonate, and kaolin.

2. The vegetable oil composition of claim 1, wherein the solid fraction is crystallised in the beta prime conformation.

3. A method for processing a vegetable oil comprising a step of adding an inorganic particulate material to the oil, wherein the amount of inorganic particulate material added is from about 0.001% to less than 1% by weight of the starting oil, wherein the inorganic particulate material is selected from the group consisting of talc, calcium carbonate, and kaolin.

4. (canceled)

5. The method of claim 3, wherein the inorganic particulate material has a d₅₀ of from about 0.5 to about 30 μm.

6. The method of claim 3, wherein the inorganic particulate material is a food additive grade talc.

7. The method of claim 3, wherein the cycle time of the processing method is reduced by at least 6% by comparison with the cycle time of the same processing method, but in the absence of any inorganic particulate material.

8. The method of claim 3, wherein the iodine value of the low iodine value fraction obtained by said method is lower than the iodine value of the tow iodine value fraction obtained by the same processing method but in the absence of any inorganic particulate material.

9. An oil product obtained by the method of claim 3.

10. The method of claim 7, wherein the inorganic particulate material acts as an adjuvant in the processing of a vegetable oil.

11. The vegetable oil composition of claim 1, wherein the inorganic particulate material has a d₅₀ of from about 0.5 to about 30 μm.

12. The vegetable oil composition of claim 11, wherein the inorganic particulate material is a food additive grade talc.

13. The vegetable oil composition of claim 11, wherein the inorganic particulate material is a macrocrystalline tab.

14. The vegetable oil composition of claim 11, wherein the inorganic particulate material is a microcrystalline talc.

15. The vegetable oil composition of claim 11, wherein the inorganic particulate material is a chloritic talc.

16. The method of claim 3, wherein the inorganic particulate material is a microcrystalline talc.

17. The method of claim 3, wherein the inorganic particulate material is a microcrystalline talc.

18. The method of claim 3, wherein the inorganic particulate material is a chloritic talc.
